(19) United States
(12) Patent Application Publication
(10) Pub. No.: US 2024/0193693 A1
(43) Pub. Date: Jun. 13, 2024

(54) INTEGRATED AND HOLISTIC ASSET MANAGEMENT

(71) Applicant: Baker Hughes Holdings LLC, Houston, TX (US)

(72) Inventors: Sunhil Kutty, Maharashtra (IN); Mandar Joshi, Maharashtra (IN); Sahil Gandhi, Dubai (AE); Sandeep Patil, Maharashtra (IN)

(21) Appl. No.: 18/514,465

(22) Filed: Nov. 20, 2023

Related U.S. Application Data
(60) Provisional application No. 63/430,821, filed on Dec. 7, 2022.

(51) Int. Cl. G06Q 40/06

(52) U.S. Cl. CPC G06Q 40/06

(57) ABSTRACT

A method for integrated and holistic asset management within a unified model is provided. The method can include receiving a unique identifier corresponding to an asset, mapping, based on the unique identifier, the asset to a plurality of asset management systems, wherein the plurality of asset management systems are each arranged to manage one or more aspects of a plurality of aspects of the asset. The method also includes receiving, from the plurality of asset management systems, data characterizing the plurality of aspects of asset, generating a unified model of the asset including the data characterizing the plurality of aspects of asset from the plurality of asset management systems, generating a first graphical user interface (GUI) of the unified model and providing the GUI within a user interface display.

### RELATED APPLICATION

This application claims priority under 35 U.S.C. § 119(e) to U.S. Provisional Application No. 63/430,821 filed Dec. 7, 2022, the entire contents of which are hereby expressly incorporated by reference herein.

### BACKGROUND

Industrial operators deploy multiple systems/techniques to monitor and optimize the asset performance and asset health. Characteristics monitored can include, but are not limited to, mechanical performance/health, process performance/health, instrument performance/health, reliability, integrity etc. Traditionally, the data from these systems/techniques are siloed or stored exclusively within separate systems. As a result, users have to interact with data in a variety of separate systems and then manually correlate the data from the separate systems in order to execute holistic asset management.

### SUMMARY

In one aspect, a method for integrated and holistic asset management within a unified model is provided. In some aspects, the method can include receiving a unique identifier corresponding to an asset, mapping, based on the unique identifier, the asset to a plurality of asset management systems, wherein the plurality of asset management systems are each arranged to manage one or more aspects of a plurality of aspects of the asset. The method also includes receiving, from the plurality of asset management systems, data characterizing the plurality of aspects of asset, generating a unified model of the asset including the data characterizing the plurality of aspects of asset from the plurality of asset management systems, generating a first graphical user interface (GUI) of the unified model and providing the GUI within a user interface display.

In another embodiment, the plurality of asset management systems include any of a performance monitoring system, a condition monitoring system, a reliability monitoring system, a strategy management system, an analytics system and a work management system.

In another aspect, the method can include determining, based on the unified model, one or more inferences about the asset and providing the one or more inferences to one or more of the plurality of asset management systems. In another aspect, the method can include receiving a plurality of unique identifiers for a plurality of assets, wherein the first GUI of the unified model includes a first list of the plurality of assets. In another aspect, the method can also include receiving a selection within the first GUI, from a user, of an asset within the first list, generating a second GUI of the unified model comprising a visual representation of the plurality of asset management systems mapped to the asset and providing the second GUI within the user interface display.

In another aspect, the method can include receiving a selection within the second GUI, from a user, of an asset management system of the plurality of asset management systems within the visual representation, generating a third GUI of the unified model identifying the one or more aspects managed by the selected asset management system and providing the third GUI within the user interface display.

In another aspect, the method can include receiving a selection within the second GUI, from a user, of an asset management system of the plurality of asset management systems within the visual representation and providing an executable instance of an application corresponding to the selected asset management system.

In another aspect, the method can include receiving metadata for each asset of the plurality of assets characterizing a site of the asset, and a system that the asset is a component of.

In another aspect, the mapping can further include generating a plurality of application programming interfaces (APIs) configured to communicatively couple the unified model to the plurality of asset management systems.

In another aspect, a system for integrated and holistic asset management within a unified model is provided. In some aspects, the system can include a computing system including at least one data processor and a memory storing instructions which, when executed by the at least one processor, cause the at least one processor to perform operations including receiving a unique identifier corresponding to an asset, mapping, based on the unique identifier, the asset to a plurality of asset management systems, wherein the plurality of asset management systems are each configured to manage one or more aspects of a plurality of aspects of the asset, receiving, from the plurality of asset management systems, data characterizing the plurality of aspects of asset, generating a unified model of the asset including the data characterizing the plurality of aspects of asset from the plurality of asset management systems, generating a first graphical user interface (GUI) of the unified model and providing the first GUI within a user interface display communicatively coupled to the computing system.

In another embodiment, the plurality of asset management systems include any of a performance monitoring system, a condition monitoring system, a reliability monitoring system, a strategy management system, an analytics system and a work management system. In another aspect, the data characterizing the plurality of aspects of asset can include, but is not limited to information regarding any of asset performance, asset condition, asset reliability, asset strategy, asset analytics and asset work management.

In another aspect, the processor is further arranged to perform operations including determining, based on the unified model, one or more inferences about the asset and providing the one or more inferences to one or more of the plurality of asset management systems.

In another aspect, the processor is further arranged to perform operations including receiving a plurality of unique identifiers for a plurality of assets, wherein the first GUI of the unified model comprises a first list of the plurality of assets.

In another aspect, the processor is further arranged to perform operations including receiving a selection within the first GUI, from a user, of an asset within the first list, generating a second GUI of the unified model comprising a visual representation of the plurality of asset management systems mapped to the asset, and providing the second GUI within the user interface display.

In another aspect, the processor is further arranged to perform operations including receiving a selection within the second GUI, from a user, of an asset management system of the plurality of asset management systems within the visual representation, generating a third GUI of the unified model identifying the one or more aspects managed by the selected asset management system and providing the third GUI within the user interface display.

In another aspect, the processor is further arranged to perform operations including receiving a selection within the second GUI, from a user, of an asset management system of the plurality of asset management systems within the visual representation and providing an executable instance of an application corresponding to the selected asset management system. In another aspect, the executable instance of the application is provided in the context of the selected asset.

In another aspect, the processor is further arranged to perform operations including receiving metadata for each asset of the plurality of assets characterizing a site of the asset, and a system that the asset is a component of.

In another embodiment, the mapping can further include generating a plurality of application programming interfaces (APIs) to communicatively couple the unified model to the plurality of asset management systems.

The systems and methods herein can provide integrated access points for users to access different representations of an asset without updating back-end aspects of the system. Providing this ability to integrate data for holistic asset management provides competitive differentiation to other state of the art products in the asset management space.

### DESCRIPTION OF DRAWINGS

These and other features will be more readily understood from the following detailed description taken in conjunction with the accompanying drawings, in which:

FIG. 1 illustrates an embodiment of a system for holistic asset management of one or more assets as described herein,

FIG. 2 illustrates an example of a graphical user interface (GUI) of an integrated model that can be generated by the system described herein,

FIG. 3 is a flow diagram of a method for integrated, holistic asset management according using the systems described herein, and

FIG. 4 is a block diagram of an example architecture of a computing system(s) or device(s) described herein.

It is noted that the drawings are not necessarily to scale. The drawings are intended to depict only typical aspects of the subject matter disclosed herein, and therefore should not be considered as limiting the scope of the disclosure.

### DETAILED DESCRIPTION

Asset condition monitoring, strategy, integrity, performance, process optimization, reliability, analytics and others similar systems, are pillars of asset performance management programs. Asset strategy/reliability techniques can include, for example, risk calculation, defect identification, defect elimination. Traditionally, assets under management have a plurality of digital instances within a plurality of disparate, non-communicating asset management systems. In this case, systems for asset condition monitoring, systems for asset strategy/reliability techniques and systems for asset analytics are operated in silos. Further, each system can have a unique representation of the assets defined or being monitored. The siloing of data corresponding to asset condition, asset strategy/reliability techniques and asset analytics in respective systems can be problematic, as navigating between individual systems can require a high level of understanding by the user to manually navigate between such systems in order to develop or provide an understanding of the health of an asset. Accordingly, using traditional systems, it can be difficult to get a holistic representation of the asset within a single system, and the user must switch between multiple systems or applications to access the particular asset representation and relevant capabilities of the asset.

The systems and methods described herein address the aforementioned shortcomings by providing an integrated model for holistic asset management, integrating assets under management that are traditionally managed using disparate systems into individual representations of the assets into single virtual representations. In some embodiments, the integrated model for asset under management can reference underlying source systems without exposing their inherent complexities. The solution provided allows a user to access all relevant information regarding an individual asset as well as all of capabilities of the referenced disparate source systems without having to switch the context across different application representations. For example, traditionally, a user may have use one application for strategy management of an asset and use a different application for condition monitoring of the same asset. Accordingly, by leveraging asset identification and references to underlying source systems, the systems and methods described herein provide a single application, user interface, or display space for holistic asset management. Thus, the systems and methods described herein eliminate the problem that arises when users have to rely siloed applications for managing different aspects of the asset (e.g., asset condition, asset strategy/reliability techniques, asset analytics, etc.).

Some embodiments of the systems and methods described herein can provide a user with the ability to access information like maintenance strategy, maintenance cost, machine history/records, work-orders and other work management artifacts from different systems using same hierarchy node selection as may be implanted in respective, disparate systems or applications. The systems and methods described herein further provide an advantage of differentiating from other asset management systems to enable higher adoption of the asset management systems and methods described herein. The integrated systems and methods described herein are capable of integrating the wide range of asset data discussed above into a unified model, accessible at one location, thus providing a user with a comprehensive, automated analysis of assets within the system. The systems and methods described herein also leverage data visualization and other intuitive techniques in order to provide an optimal user experience, as described in greater detail below.

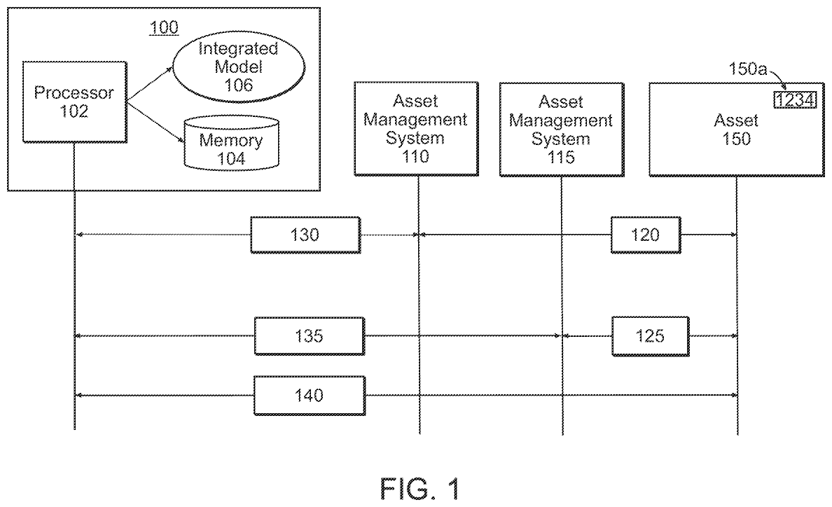

FIG. 1 illustrates an embodiment of a system 100 for holistic asset management of one or more assets, e.g., asset 150. In some embodiments, the system 100 can include a computing system including at least one processor 102 and a memory 104, as discussed in greater detail below. The holistic asset management system 100 can be communicatively coupled to a plurality of disparate asset management systems 110, 115 as well as the asset 150. The system 100 can include an integrated model 106 which is configured to integrate a plurality of asset management data streams from the plurality of asset management systems 110, 115 into the integrated model 106 that is accessible to a user through a single application, user interface, or display space. In some embodiments, the plurality of asset management systems 110, 115 can include, for example, a strategy management system 110 and a condition monitoring system 115. In other aspects, the asset management systems 110, 115 can also include, but are not limited to any of a performance monitoring system, a condition monitoring system, a work management system, a reliability monitoring system, a maintenance strategy system, a mechanical integrity system, an analytics system or the like. Representations of the plurality of asset management systems 110, 115 can be unified and displayed within the integrated model 106. In some embodiments the plurality of asset management systems 110, 115 can be configured to collect data at 120, 125, respectively, from the asset 150. The data 120, 125 can include information characterizing one or more aspects of the asset 150, as discussed in greater detail below. The data 120, 125 collected by the plurality of asset management systems 110, 115 can then be provided to the system 100 at 130, 135, respectively. In some embodiments, the data 130, 135 can be provided to at least one processor 102 of the system 100. For example, in a case where the asset 150 is being managed by the asset management systems 110, 115, the asset management systems 110, 115 can be configured to gather data at 120, 125, respectfully, regarding one or more aspects of the asset 150, depending on what the systems 110, 115 are managing. In some cases, the one or more aspects can include, but are not limited to, mechanical data, process data, performance data, operational planning data, emissions data, instrumentation data, anomaly/condition detection data, analytics, integrity data, reliability data, maintenance histories/costs data, lubrication data, etc.

Once the data 120, 125 is collected and analyzed by the plurality of asset management systems 110, 115, the system 100 can be configured to receive the analyzed data from the plurality of asset management systems 110, 115 at 130, 135, respectively. In some embodiments, the system 100 can be configured to receive the data at 130, 135 via a plurality of APIs or the like (e.g., a REST API call). The system 100 can also be configured to receive metadata at 140 from the asset 150 including, but not limited to, a unique identifier 150a of the asset 150, a site/location of the asset 150 and a system that the asset 150 is a component of. In some embodiments, the system 100 can be communicatively coupled to the asset 150, however, in some embodiments, the system 100 can be configured to receive the metadata 140 from the plurality of asset management systems 110, 115. In some embodiments, the system 100 can be configured to identify individual assets 150 based on the metadata received at 140 (e.g., the unique identifier 150a). As the system 100 receives the data at 130, 135 from the plurality of asset management systems 110, 115, the processor 102 can be configured to determine, using the metadata received at 140, that the data received at 130 the asset management system 110 and the data received at 135 from the asset management system 115 correspond to the same individual asset 150. In this way, the system 100 can provide a means for mapping, accessing and interacting with data collected at 130, 135 by disparate systems 110, 115 regarding an individual asset 150 from a single access or interaction point, via the integrated model 106. In some embodiments, the system 100 can be configured to generate a graphical user interface (GUI) of the integrated model 106 and provide the GUI to a user interface display that is communicatively coupled to the system 100, as discussed in greater detail below.

Further, in some embodiments, the data received by the system 100 at 130, 135 by disparate systems 110, 115 regarding an individual asset 150 can be combined an analyzed within the unified model 106 of the system 100. Once the system 100 combines and comprehensively analyzes the data, the system 100 can be configured to derive asset management information configured to optimize the asset management capabilities of each of the plurality of systems 110, 115 individually. The system 100 can be configured to transmit the insights from the comprehensive analysis of the data from the plurality of systems back to each system 110, 115 at 130, 135, as indicated in FIG. 1. In this way, the systems and methods described herein are capable of better leveraging the use of disparate asset management systems 110, 115 by providing each system 110, 115 with the comprehensive, collaborative analytics determined by the integrated model 106.

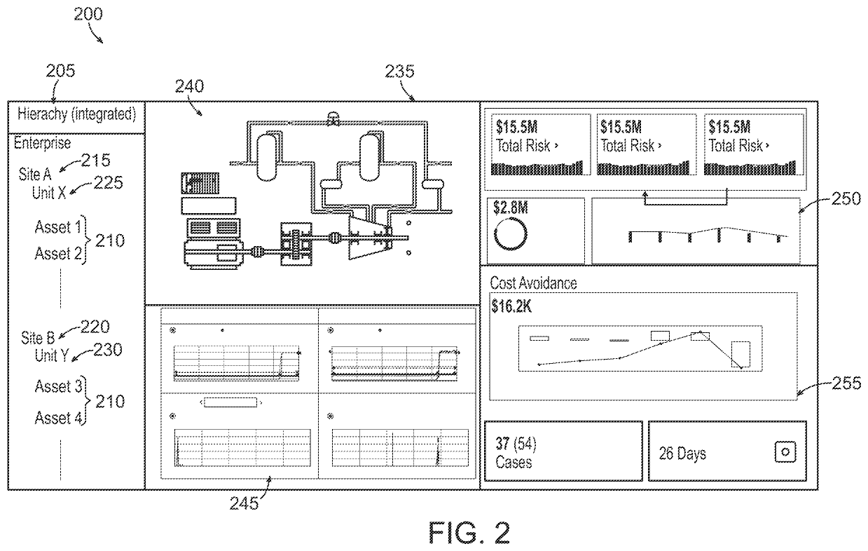

FIG. 2 illustrates an example of a GUI 200 of the integrated model (e.g., 106 of FIG. 1) that can be generated by the system described herein (e.g., 100 of FIG. 1). In some embodiments, the GUI can include a list 205 of a plurality of assets 210. As described above, with reference to FIG. 1, the processor 102 can be configured receiving a plurality of unique identifiers for a plurality of assets 210 in order to map the data received from the plurality of disparate asset management systems 110, 115 regarding each of the plurality of assets 210 to the proper asset of the plurality. Further, as described above, the metadata received can include a site/location 215, 220 of each asset in the plurality of assets 210 as well as a system/unit 225, 230 that each asset is a component of. In some aspects, the list 205 can be organized hierarchically from the site 215, 220 of the asset to the system/unit 225, 230 that the asset is a component of, as shown in the list 205. However, other hierarchical organizations can also be realized.

In some aspects, a user can interact with the GUI 200 to select an asset of the plurality of assets 210 within the list 205. Responsive to the selection of an asset within the list 205, the system can be configured to generate an instance of a unified model 235 for the comprising a plurality of visual representations 240, 245, 250 of a plurality of asset management systems mapped to the asset. For example, in some cases, the instance of the unified model 235 of the selected asset of the plurality of assets 210 can include a visual representation 240 of a first asset management system configured to manage one or more first aspects of the selected asset. In some aspects, for example, the first asset management system can be a condition monitoring system and the one or more first aspects can include data characterizing anomaly/condition detection for the selected asset. Similarly, in some aspects, the instance of the unified model 235 of the selected asset of the plurality of assets 210 can include a visual representation 245 of a second asset management system configured to manage one or more second aspects of the selected asset. For example, the second asset management system can be a performance monitoring system and the one or more second aspects can include data characterizing performance of the selected asset. Additionally, in some aspects, the instance of the unified model 235 of the selected asset of the plurality of assets 210 can include a visual representation 250 of a third asset management system configured to manage one or more third aspects of the selected asset. For example, the third asset management system can be a maintenance/operation cost monitoring system, or the like, and the one or more third aspects can include data characterizing maintenance histories/costs of operation for the selected asset. Furthermore, in some aspects, the instance of the unified model 235 of the selected asset of the plurality of assets 210 can include a comprehensive visual representation 255. In some aspects, the comprehensive visual representation 255 can be a visual representation that is generated based on the one or more first, second and third aspects of the selected asset, from the plurality of visual representations 240, 245, 250 of the plurality of asset management systems mapped to the asset. For example, the visual representation 255 can be an analytics/work visual representation including data characterizing analytics/operational planning for the selected asset (e.g., cost avoidance metrics) based on a comprehensive correlation of the data from the plurality of visual representations 240, 245, 250 of the plurality of asset management systems mapped to the asset. Accordingly, the systems and methods provided herein enable a user to access and interact with asset information stored in disparate asset management systems or applications from or at a single access point, advantageously providing comprehensive holistic asset management capabilities.

In some aspects, the user can further provide a selection of one of the plurality of visual representations 240, 245, 250, 255 of the plurality of asset management systems mapped to the asset. Responsive to the selection of a visual representations 240, 245, 250, 255, the system can be configured to generate a more comprehensive instance of the selected visual representation of the asset management system mapped to the asset. In some embodiments, the more comprehensive instance of the selected visual representation can include a full screen view of the selected visual representation. In other aspects, the more comprehensive instance of the selected visual representation can be an executable instance of the application corresponding to the asset management system providing the data for the selected visual representation. For example, in a case where a user wishes to interact directly with the asset via the asset management system providing the data for the selected visual representation, responsive to a selection of a visual representations, the system can be configured to launch an instance of the asset management system within the system (e.g., a web application corresponding to the selected asset management system). In some embodiments, the launched executable instance of the asset management system selected can be configured to open directly into the context of the selected asset provided by the selected visual representation. In some aspects, responsive to the selection of a visual representations 240, 245, 250, 255, the system can be configured to generate an additional GUI wherein the user may add notes, tags or other metadata regarding the selected asset to be saved along with the visual representation selected.

Similarly, in some aspects, the user can further provide a selection of an asset of the plurality of assets 210, a site 215, 220 or a unit 225, 230 within the list 205. For example, responsive to a user selection of an asset of the plurality of assets 210, a site 215, 220 or a unit 225, 230 within the list 205, the system can be configured to generate an additional GUI that can include a plurality of modifiable fields wherein the user may add notes, tags or other metadata regarding the selected asset, site or unit to be saved within the system. Further, in some aspects, any data input or generated within the unified model can be transmitted back to each disparate asset management system to improve their independent operations, as described above.

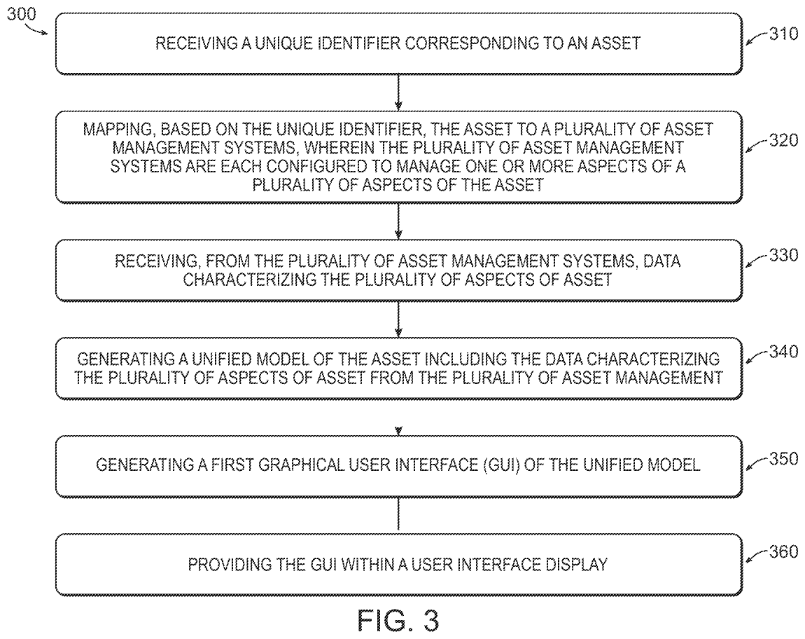

FIG. 3 illustrates a flow diagram of a method 300 for integrated, holistic asset management. The method 300 can include a step 310 of receiving a unique identifier and/or other metadata corresponding to an asset. As described above, in some embodiments, the unique identifier can be received from one or more disparate asset management systems and/or directly from the asset, or a user input.

The method 300 can also include a step 320 of mapping, based on the unique identifier or the other metadata, the asset to a plurality of asset management systems, wherein the plurality of asset management systems are each configured to manage one or more aspects of a plurality of aspects of the asset. In some embodiments, the mapping at 320 can be done automatically by the system, or manually by a user interacting with the system.

The method 300 can also include a step 330 of receiving, from the plurality of asset management systems, data characterizing the plurality of aspects of asset. The method 300 can further include a step 340 of generating a unified model of the asset including the data characterizing the plurality of aspects of asset from the plurality of asset management systems. The method 300 also includes a step 350 of generating a graphical user interface (GUI) of the unified model, as discussed above in reference to FIG. 2. The method 300 further includes a step 360 of providing the GUI within a user interface display. In some embodiments, for example can be executed on a laptop/desktop computer or tablet, and the step 360 can include providing the GUI to a screen/touchscreen of the laptop/desktop computer or tablet.

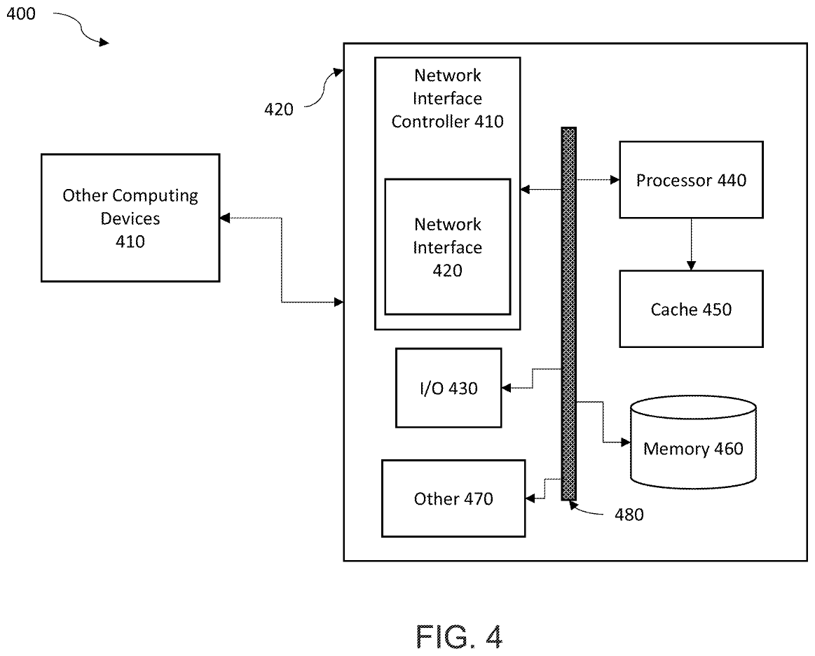

FIG. 4 is a block diagram of an example architecture 400 of a computing system or device, such as the computing system 420 configured to receive data from one or more other computing devices/systems 410. For example, in reference to FIG. 2, in some aspects, the computing system 420 can be similar to the system 100, and the one or more other computing devices/systems 410 can include other asset management systems 110, 115 as well as the asset 150. In broad overview, the computing system 420 can include at least one processor 440 for performing actions in accordance with instructions, and one or more memory devices 450 and/or 460 for storing instructions and data. The illustrated example computing system 420 includes one or more processors 440 in communication, via a bus 480, with memory 460 and with at least one network interface controller 410 with a network interface 420 for connecting to the other computing devices 410. The one or more processors 440 are also in communication, via the bus 480, with each other and with the plurality of other computing devices 410, and any other devices 470. The processor 440 illustrated incorporates, or is directly connected to, cache memory 450. Generally, a processor will execute instructions received from memory. In some embodiments, the computing system 420 can be configured within a cloud computing environment, a virtual or containerized computing environment, and/or a web-based microservices environment.

In more detail, the processor 440 can be any logic circuitry that processes instructions, e.g., instructions fetched from the memory 460 or cache 450. In many embodiments, the processor 440 is an embedded processor, a microprocessor unit or special purpose processor. The computing system 420 can be based on any processor, e.g., suitable digital signal processor (DSP), or set of processors, capable of operating as described herein. In some embodiments, the processor 440 can be a single core or multi-core processor. In some embodiments, the processor 440 can be composed of multiple processors.

The memory 460 can be any device suitable for storing computer readable data. The memory 460 can be a device with fixed storage or a device for reading removable storage media. Examples include all forms of non-volatile memory, media and memory devices, semiconductor memory devices (e.g., EPROM, EEPROM, SDRAM, flash memory devices, and all types of solid state memory), magnetic disks, and magneto optical disks. A computing device 420 can have any number of memory devices 460.

The cache memory 450 is generally a form of high-speed computer memory placed in close proximity to the processor 440 for fast read/write times. In some implementations, the cache memory 450 is part of, or on the same chip as, the processor 440.

The network interface controller 410 manages data exchanges via the network interface 420. The network interface controller 410 handles the physical, media access control, and data link layers of the Open Systems Interconnect (OSI) model for network communication. In some implementations, some of the network interface controller's tasks are handled by the processor 440. In some implementations, the network interface controller 410 is part of the processor 440. In some implementations, a computing device 420 has multiple network interface controllers 410. In some implementations, the network interface 420 is a connection point for a physical network link, e.g., an RJ 45 connector. In some implementations, the network interface controller 410 supports wireless network connections via network interface port 420. Generally, a computing device 420 exchanges data with the other computing devices 410, via physical or wireless links to a network interface 420. In some implementations, the network interface controller 410 implements a network protocol such as LTE, TCP/IP Ethernet, IEEE 802.11, IEEE 802.16, or the like.

The other computing devices 410 can be connected to the computing device 420 via a network interface port 420. The other devices 470 can include an I/O interface 430, external serial device ports, and any additional co-processors. For example, a computing system 420 can include an interface (e.g., a universal serial bus (USB) interface, or the like) for connecting input devices (e.g., a keyboard, microphone, mouse, or other pointing device), output devices (e.g., video display, speaker, refreshable Braille terminal, or printer), or additional memory devices (e.g., portable flash drive or external media drive). In some implementations an I/O device is incorporated into the computing system 420, e.g., a touch screen on a tablet device. In some implementations, a computing device 420 includes an additional device 470 such as a co-processor, e.g., a math co-processor that can assist the processor 440 with high precision or complex calculations.

Certain exemplary embodiments have been described to provide an overall understanding of the principles of the structure, function, manufacture, and use of the systems, devices, and methods disclosed herein. One or more examples of these embodiments have been illustrated in the accompanying drawings. Those skilled in the art will understand that the systems, devices, and methods specifically described herein and illustrated in the accompanying drawings are non-limiting exemplary embodiments and that the scope of the present invention is defined solely by the claims. The features illustrated or described in connection with one exemplary embodiment can be combined with the features of other embodiments. Such modifications and variations are intended to be included within the scope of the present invention. Further, in the present disclosure, like-named components of the embodiments generally have similar features, and thus within a particular embodiment each feature of each like-named component is not necessarily fully elaborated upon.

The subject matter described herein can be implemented in analog electronic circuitry, digital electronic circuitry, and/or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine-readable storage device), or embodied in a propagated signal, for execution by, or to control the operation of, data processing apparatus (e.g., a programmable data processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable data processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application-specific integrated circuit).

Data processors suitable for the execution of a computer program include, by way of example, both general and special purpose microprocessors, and any one or more processor of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, (e.g., EPROM, EEPROM, and flash memory devices); magnetic disks, (e.g., internal hard disks or removable disks); magneto-optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The techniques described herein can be implemented using one or more modules. As used herein, the term “module” refers to computing software, firmware, hardware, and/or various combinations thereof. At a minimum, however, modules are not to be interpreted as software that is not implemented on hardware, firmware, or recorded on a non-transitory processor readable recordable storage medium (i.e., modules are not software per se). Indeed “module” is to be interpreted to always include at least some physical, non-transitory hardware such as a part of a processor or computer. Two different modules can share the same physical hardware (e.g., two different modules can use the same processor and network interface). The modules described herein can be combined, integrated, separated, and/or duplicated to support various applications. Also, a function described herein as being performed at a particular module can be performed at one or more other modules and/or by one or more other devices instead of or in addition to the function performed at the particular module. Further, the modules can be implemented across multiple devices and/or other components local or remote to one another. Additionally, the modules can be moved from one device and added to another device, and/or can be included in both devices.

The subject matter described herein can be implemented in a computing system that includes a back-end component (e.g., a data server), a middleware component (e.g., an application server), or a front-end component (e.g., a client computer having a graphical user interface or a web browser through which a user can interact with an implementation of the subject matter described herein), or any combination of such back-end, middleware, and front-end components. The components of the system can be interconnected by any form or medium of digital data communication, e.g., a communication network. Examples of communication networks include a local area network (“LAN”) and a wide area network (“WAN”), e.g., the Internet.

Approximating language, as used herein throughout the specification and claims, can be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language can correspond to the precision of an instrument for measuring the value. Here and throughout the specification and claims, range limitations can be combined and/or interchanged, such ranges are identified and include all the sub-ranges contained therein unless context or language indicates otherwise.

The use of the terms “a” and “an” and “the” and similar referents in the context of describing the disclosure (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “approximately” includes within 1, 2, 3, or 4 standard deviations. In certain embodiments, the term “about” or “approximately” means within 50%, 20%, 15%, %, 9%, 8%, 7%, 6%, 5%, 4%, 3%, 2%, 1%, 0.5%, or 0.05% of a given value or range. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

One skilled in the art will appreciate further features and advantages of the invention based on the above-described embodiments. Accordingly, the present application is not to be limited by what has been particularly shown and described, except as indicated by the appended claims. All publications and references cited herein are expressly incorporated by reference in their entirety.

1. A method comprising:
receiving a unique identifier corresponding to an asset;
mapping, based on the unique identifier, the asset to a plurality of asset management systems, wherein the plurality of asset management systems are each configured to manage one or more aspects of a plurality of aspects of the asset;
receiving, from the plurality of asset management systems, data characterizing the plurality of aspects of asset;
generating a unified model of the asset including the data characterizing the plurality of aspects of asset from the plurality of asset management systems;
generating a first graphical user interface (GUI) of the unified model; and
providing the GUI within a user interface display.

2. The method of claim 1, wherein the plurality of asset management systems comprise any of a performance monitoring system, a condition monitoring system, a reliability monitoring system, a strategy management system, an analytics system and a work management system.

3. The method of claim 1, further comprising:
determining, based on the unified model, one or more inferences about the asset; and
providing the one or more inferences to one or more of the plurality of asset management systems.

4. The method of claim 1, further comprising receiving a plurality of unique identifiers for a plurality of assets, wherein the first GUI of the unified model comprises a first list of the plurality of assets.

5. The method of claim 4, further comprising:
receiving a selection within the first GUI, from a user, of an asset within the first list;
generating a second GUI of the unified model comprising a visual representation of the plurality of asset management systems mapped to the asset; and
providing the second GUI within the user interface display.

6. The method of claim 5, further comprising:
receiving a selection within the second GUI, from a user, of an asset management system of the plurality of asset management systems within the visual representation;
generating a third GUI of the unified model identifying the one or more aspects managed by the selected asset management system; and
providing the third GUI within the user interface display.

7. The method of claim 5, further comprising:
receiving a selection within the second GUI, from a user, of an asset management system of the plurality of asset management systems within the visual representation; and
providing an executable instance of an application corresponding to the selected asset management system.

8. The method of claim 4, further comprising receiving metadata for each asset of the plurality of assets characterizing a site of the asset, and a system that the asset is a component of.

9. The method of claim 1, wherein the mapping further comprises generating a plurality of application programming interfaces (APIs) configured to communicatively couple the unified model to the plurality of asset management systems.

10. A system comprising:
a computing system including at least one data processor and a memory storing instructions which, when executed by the at least one processor, cause the at least one processor to perform operations comprising
receiving a unique identifier corresponding to an asset;
mapping, based on the unique identifier, the asset to a plurality of asset management systems, wherein the plurality of asset management systems are each configured to manage one or more aspects of a plurality of aspects of the asset;
receiving, from the plurality of asset management systems, data characterizing the plurality of aspects of asset;
generating a unified model of the asset including the data characterizing the plurality of aspects of asset from the plurality of asset management systems;
generating a first graphical user interface (GUI) of the unified model; and
providing the first GUI within a user interface display communicatively coupled to the computing system.

11. The system of claim 10, wherein the plurality of asset management systems comprise any of a performance monitoring system, a condition monitoring system, a reliability monitoring system, a strategy management system, an analytics system and a work management system.

12. The system of claim 11, wherein the data characterizing the plurality of aspects of asset comprise information regarding any of asset performance, asset condition, asset reliability, asset strategy, asset analytics and asset work management.

13. The system of claim 10, wherein the processor is further configured to perform operations comprising:
determining, based on the unified model, one or more inferences about the asset; and
providing the one or more inferences to one or more of the plurality of asset management systems.

14. The system of claim 10, wherein the processor is further configured to perform operations comprising receiving a plurality of unique identifiers for a plurality of assets, wherein the first GUI of the unified model comprises a first list of the plurality of assets.

15. The system of claim 14, wherein the processor is further configured to perform operations comprising:
receiving a selection within the first GUI, from a user, of an asset within the first list;
generating a second GUI of the unified model comprising a visual representation of the plurality of asset management systems mapped to the asset; and
providing the second GUI within the user interface display.

16. The system of claim 15, wherein the processor is further configured to perform operations comprising:
receiving a selection within the second GUI, from a user, of an asset management system of the plurality of asset management systems within the visual representation;
generating a third GUI of the unified model identifying the one or more aspects managed by the selected asset management system; and
providing the third GUI within the user interface display.

17. The system of claim 15, wherein the processor is further configured to perform operations comprising:
receiving a selection within the second GUI, from a user, of an asset management system of the plurality of asset management systems within the visual representation; and
providing an executable instance of an application corresponding to the selected asset management system.

18. The system of claim 17, wherein the executable instance of the application is provided in the context of the selected asset.

19. The system of claim 14, wherein the processor is further configured to perform operations comprising receiving metadata for each asset of the plurality of assets characterizing a site of the asset, and a system that the asset is a component of.

20. The system of claim 10, wherein the mapping further comprises generating a plurality of application programming interfaces (APIs) configured to communicatively couple the unified model to the plurality of asset management systems.
